(19) United States
(12) Patent Application Publication
(10) Pub. No.: US 2008/0240595 A1
(43) Pub. Date: Oct. 2, 2008

(54) Data Exchange Method

(75) Inventor: Adrian Le Hanne, Berlin (DE)

Correspondence Address: CONNOLLY BOVE LODGE & HUTZ LLP, 1875 EYE STREET, N.W., SUITE 1100, WASHINGTON, DC, 20036, US

(73) Assignee: ICONMOBILE GMBH, Berlin (DE)

(21) Appl. No.: 12/057,429

(22) Filed: Mar. 28, 2008

(30) Foreign Application Priority Data
Mar. 30, 2007 (DE) 102007015514.1

(51) Int. Cl. G06K 9/48

(52) U.S. Cl. 382/243

(57) ABSTRACT

In order to exchange data together with a pre-defined basic logo in coded form, a geometric basic shape, preferably matching the pattern of the basic logo, is defined as the coding symbol and a matrix likewise matching the arrangement of the coding symbols and therefore encoded data, which can be read out automatically after being photographed with a CCD sensor by the decoding algorithm embedded there and also trigger off further associated automatic routines, for example the calling-up of an internet address, are contained in a coding part next to or in the basic logo.

### CROSS-REFERENCE TO RELATED APPLICATIONS

This application claims priority to German Patent Application No. 102007015514.1, filed on Mar. 30, 2007, the entire disclosure of which is incorporated herein by reference.

### FIELD OF THE INVENTION

The invention relates to a method for exchanging digital data with the aid of a logo.

### BACKGROUND

It is known to exchange digital data by means of so-called data matrix code symbols (tags).

In this regard, the Semacode, which is used in Germany for electronic franking of envelopes or the QR code which, originating from Japan, is used in the automotive industry, is known for example.

Both kinds of tags consist of a two-dimensional matrix of square pixels, whose light-dark sequence represents the encoded data.

Such tags can be photographed by optical sensors, for example, also the CCD sensor of a digital camera, as built into most cellular phones, and are analyzed and deciphered with a program embedded in the respective processor of the cellular phone, so that re-processable digital data are then available, although they could be simply further transmitted beforehand in the form of graphics which can also be sent by analog transmission.

The disadvantage of the known data matrix code symbols is the fact that the corresponding tags appear very technical and do not produce a definite visual pattern recognizable again by the layman.

They are, therefore, not practical for use in the field of advertising, where visual association with a logo, which can be again recognized by the viewer (letters, numbers and/or free graphics; defined coloring) is desired.

### SUMMARY OF THE INVENTION

### a) Technical Object

The object of the invention is to provide a method for exchanging information with the aid of optical symbols, which can be arrayed at least partly in order to match the desired graphic overall appearance of the logo being used, as the result of which it should be possible to recognize and analyze the graphic pattern in a simple way.

### b) Achieving the Object

This object is achieved by the features of claims 1 and 31. Advantageous embodiments are clear from the sub-claims.

The method in the currently known way uses the arrangement and/or modification of geometric, two-dimensional symbols in order to encode information.

The novelty of the method according to the invention consists in that a greater number of geometric basic shapes, which can be used for encoding, is available to do this and these geometric basic shapes supplement or change a pre-defined basic logo in a graphically advantageous way.

The first step of the method therefore consists in selecting one or more geometric basic shapes to be used for encoding from a selection of available basic shapes, or—with an unsatisfactory selection of basic shapes—in newly creating further geometric basic shapes.

As a result of such selection an overall visually substantially more uniform and also more eye-catching overall image of the coded logo can be produced than was possible with the known methods.

This is above all the case if one or more geometric basic shapes, which are used for encoding, are selected dependent on the graphic components of the pre-defined basic logo.

In most cases this will mean that the selected geometric basic shapes are 15 similar to the graphic components already present in the pre-defined basic logo.

In special cases however geometric basic shapes can also be selected, which supplement the graphic components of the basic logo or are precisely the opposite of these, in order to cause increased visual tension, greater eye-catching potential or the like, depending on the target application.

The coding part of the logo, by which the basic logo is supplemented, is then decoded by means of a coding algorithm, which for encoding uses
modifications of the selected geometric basic shapes, in particular dimension-related modifications
patterns of the geometric basic shapes specific to each other, in particular within a Cartesian or polar coordinate system for example and the matrices pre-defined thereby.

The coded logo thus created can be sent in any arbitrary way, thus also by analog transmission or in physical format, it can be arbitrarily multiplied, and also increased or reduced, without losing the encoded data content as a result. This is because the absolute dimensions of the geometric basic shapes used for encoding in the rarest cases will be a coding characteristic but rather only their relation.

Such a coded logo having been transmitted must be optically scanned for the purposes of decoding and the coding part of the logo must be identified, in other words recognized. Subsequently the coding part can be analyzed and decoded.

Preferably this is performed by machine, via optical scanning by means of a CCD sensor or other digital optical sensor for example, and also recognition of the coding part, and likewise analysis and decoding of the coding part take place by machine, usually with the aid of a computer program.

Nevertheless due to the resultant relatively simple and clear optical patterns of such coded logos, the decoding part in many cases can even be decoded manually if the data content is not too great.

For encoding, apart from the geometric basic shapes and their modifications and arrangements, in addition color graduations can also be defined for the individual coding symbols, that is to say, the geometric basic shapes, which can represent an additional data content and increase the information density.

The freedom of arrangement with this method is further increased by the fact that selection can be made not only from a pre-defined, but in principle from an almost unlimited number of geometric basic shapes and furthermore by the fact that also the coding algorithm can be individually selected if need be, so that for example analog relative arrangements of a first geometric basic shape do not necessarily have to possess the same or an analog similar sense content as the same arrangement of other geometric basic shapes.

In order to further increase the freedom of arrangement as regards the coding part of the logo, a new coding algorithm can be created instead of selecting one of the existing coding algorithms.

Only in order to keep the effort within limits however, the two geometric basic shapes available for selection as well as modifications and possible re-arrangements of these, which can be selected for encoding, will be restricted and selected accordingly.

For matching the optical pattern of the coding part to the basic logo, modifications can also be made in the selected geometric basic shapes of the coding part. Thus for example the outer contours can be changed, for example the external corners of the geometric basic shapes can be rounded, or free spaces can be provided inside the basic shapes, if this opposes the optical pattern.

In order to facilitate decoding however, directly adjoining geometric basic shapes should always contact one another along the entire boundary line, so that no narrow gaps can arise between the basic shapes directly bordering each other.

Likewise full filling out of the geometric basic shapes of the arrangement of free spaces in the basic shapes is to be preferred for reasons of better decodability.

At least two different, well-contrasting colors are needed for encoding, that is to say, the actual coding color, with which the basic shapes are coded, and the background color, against which the coding color is to stand out.

These two colors can also be selected in relation to the colors present in the basic logo, for which reason the basic logo should be examined for its graphic components preferably before the basic shapes and the coding algorithm are selected.

Additionally a complementary color can be provided as the third color, with which the basic shapes can also be filled out and which for the purposes of good decodability should likewise stand out clearly from the coding color and also from the background color.

If this is the case, color graduations either of the background color or the coding color and therefore also mixtures of both also come into question as a complementary color.

Depending on the desired information density, in this case the data content of the complementary color may be either a data content deviating from the data content of the coding color and the background color, or the complementary color is only used for improving the optical pattern and is not applicable for encoding.

In this case the complementary color with respect to the data content either equates to the coding color or to the background color and then no longer has to stand out from the corresponding color.

For decoding the logo at another place after the coded logo has been transmitted, recognition and isolation of the coding part of the logo are first necessary.

This is effected by means of so-called code symbols, which are located inside the coding part and whose purpose consists in relaying the position and the borders of the coding part and therefore of the matrix to the evaluation unit, after the basic shapes are embedded within the coding part.

These code symbols preferably likewise consist of the same geometric basic shapes as used for data encoding but are located inside the coding part either at a special position or—if a plurality of code symbols are concerned, which is preferably the case—in a certain position relative to each other, which is thus taken up or present only once within the coding part.

Since this position or relative situation of the code symbol or symbols is embodied in the coding algorithm, the evaluation unit searches the digital matrix information supplied by the optical sensor, e.g. the CCD sensor, for exactly these code symbols.

If they are detected, the type, orientation and dimension of the coordinate system and therefore also of the matrix, used for arranging the geometric basic shapes, are known through the pattern, that is to say in particular, shape, relative situation, possibly also color of the code symbols of the evaluation unit.

Accordingly there are preferably at least two different code symbols, that is to say,
position code symbols and
dimension code symbols,
   at least two of which in turn are preferably present in each case, so that the position code symbols define the orientation of the coding matrix and the dimension code symbols the matrix dimension in both matrix directions.

Additionally due to these code symbols the extent of the coding part is also transmitted, that is to say, the geometric borders of the coding part of the logo, which can be located either beside the basic logo but can also cover partially or completely with the basic logo.

Alternatively for definition of the borders of the coding part one or more separate border code symbols may also be present.

Preferably the coding part furthermore also contains one or more
check code symbols,
which however preferably lie in a separate check area outside of the remaining usable area of the coding part, in which the normal coding symbols (the arrayed geometric basic shapes) as well as the other check symbols are arranged.

The different coding algorithms therefore usually can also comprise various coordinate systems and thus coding matrices, different code symbols, usable regions, check area etc., but can also agree in individual or in all of these points.

The check code symbol as data content contains a check digit, which after the coding part has been decoded is checked for agreement with a comparison digit also to be computed from the data content of the coding part.

If check digit and comparison digit coincide, it is guaranteed that the decoding of the data content of the coding part and thus of the entire coded logo has taken place correctly.

The data content of the coding part in this case is usually a pure numerical sequence, in particular therefore without letters and other data carriers.

Also the procedure for computing the comparison digit from the data content is specified in the coding algorithm.

The dimension and orientation of the matrix and therefore the geometric basic shapes, that is to say the coding symbols, arranged inside the matrix, are preferably determined by the fact that the approximate ellipse embedded in the basic shape and its ellipse parameters, that is to say ellipse axes, intersections of the ellipse axes and possibly length of the ellipse radii are computed for each of the basic shapes used. On the basis of these the various geometric basic shapes used and their specific position and dimension are determined when the data content is read out at the individual matrix positions.

If in this way position and borders of the coding part as well as dimension and orientation of the coordinate system and therefore of the arrangement matrix for the basic shapes inside the coding part are known to the evaluation unit and likewise the significance of the individual colors (either through the coding algorithm or through a separate color code symbol) the evaluation unit can now read out the data content without any problem from the coding part by the particular data content being allocated to the basic shapes present at the individual matrix positions, with different colors being available and this data content in the pre-defined sequence, for example set row by row behind one another, representing the data content of the coding part.

The code symbols in this case are normally simply skipped over with respect to the data content when they are read out or are located outside of the usable region in a separate code region.

Since—as already described above—the comparison digit has already been established from the data content and checked for agreement with the check digit from the check code symbol, decoding of the data content in the logo is complete.

However further process steps can be embedded in the evaluation unit as routines, which are to be carried out after the data content becomes available (decoded):

Such an automatic routine after decoding could for example be the transfer of the decoded information to any, preferably automated service provider, for example a switchboard or an internet server, so that the information sent thereto triggers off a further automated reaction there, for example the relaying of a telephone number or internet address back to the evaluation unit, which is then selected—preferably again automatically—by the evaluation unit.

In a further routine of the evaluation unit this could then access this telephone number automatically.

Equally the information released by transmission of the decoded service could be the direct exchange of the content of a web page back to the evaluation unit of the user.

Also more complex applications are conceivable in this way:

For example a quantity of data could exist at the service provider, which for example represents a three-dimensional object, for example a building.

Since such three-dimensional representation on the usually only two-dimensional, existing display of the evaluation unit of the user is not realistic but at most can be displayed in two-dimensional perspective, the coding part of the logo could additionally have one or more location code symbols.

From the relative situation of the location code symbol(s) for the dimension and position of the matrix that has become known in the meantime and the position of the remaining code symbols, the momentary position of the optical sensor of the evaluation unit relative to the coding part can be determined by means of the evaluation unit, usually a programmed computer.

This relative position is relayed to the service provider with the remaining data content, which has been decoded and as a reaction the evaluation unit automatically receives from the service provider a two-dimensional, perspective view of the three dimensional object virtually embedded there from exactly the perspective of the momentary relative situation of the optical sensor, for example relative to the coding part.

If the user changes this relative situation, for example with respect to the coding part, to another line of sight and distance, thus he also receives in real time the corresponding two-dimensional, perspective views of the three-dimensional object virtually embedded at the service provider sent back as data on his display.

Consequently the user on his two-dimensional display, by moving it for example in a circular path around a point of reference, for instance the coded logo, can view the three-dimensional object embedded at the service provider from all perspectives in succession, zoom in or out etc. and thereby obtain a comprehensive, three-dimensional impression of this object.

To do this the user for decoding only needs a device which
contains as far as possible a digital, optical sensor, for example a CCD sensor,
an evaluation unit connected downstream of this sensor, in particular in the form of a programmable computer, in which the coding algorithm for decoding is embedded,
preferably a display to show the information from the service provider.

If after decoding the information one or more downstream routines are required, the device also needs access to the service provider used to do this, especially wireless access.

All these physical components are today normally included in a cellular phone with built-in digital camera, so that only the coding algorithm still has to be entered in its program memory, which must be done by the user before the method is applied.

### BRIEF DESCRIPTION OF THE DRAWINGS

Embodiments in accordance with the invention are described below in detail by way of example, where:

FIG. 1: shows examples of basic shapes as basic symbols, derived from a pre-defined basic logo,

FIG. 2: shows two examples of a finally completed logo with somewhat different basic shapes,

FIG. 3: shows the matrix code symbols in the logo,

FIG. 4: shows the color code symbols in the logos,

FIG. 5: shows the check code symbol in these logos,

FIG. 6: shows the procedure for decoding a logo,

FIG. 7: shows part of the decoding procedure and

FIG. 8: shows a particular application of the method.

### DETAILED DESCRIPTION OF THE PREFERRED EMBODIMENTS

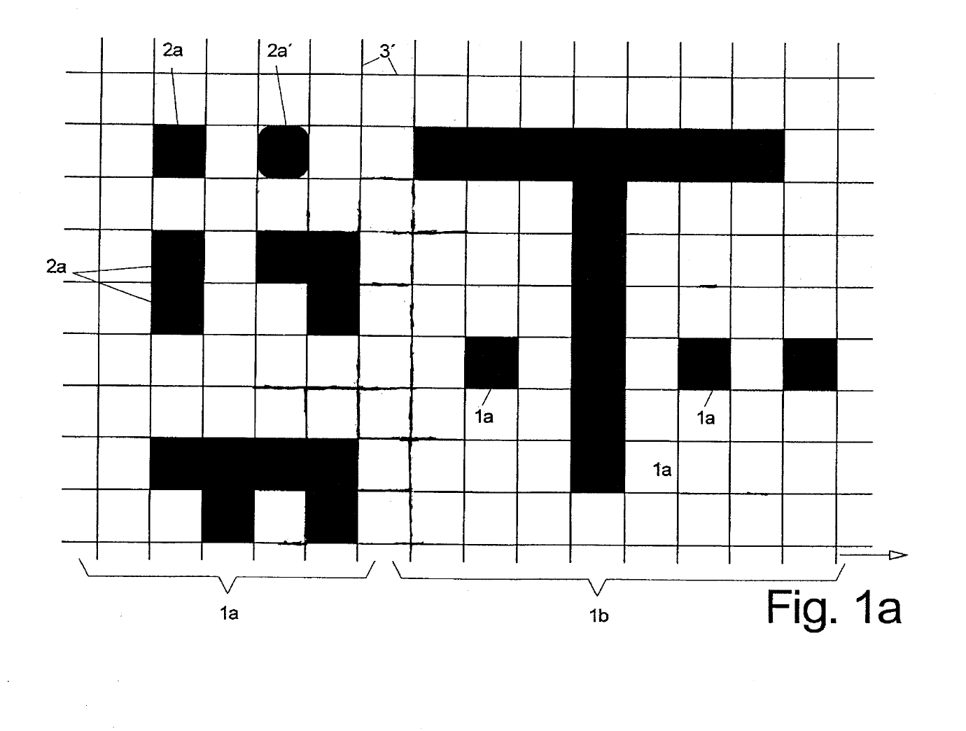

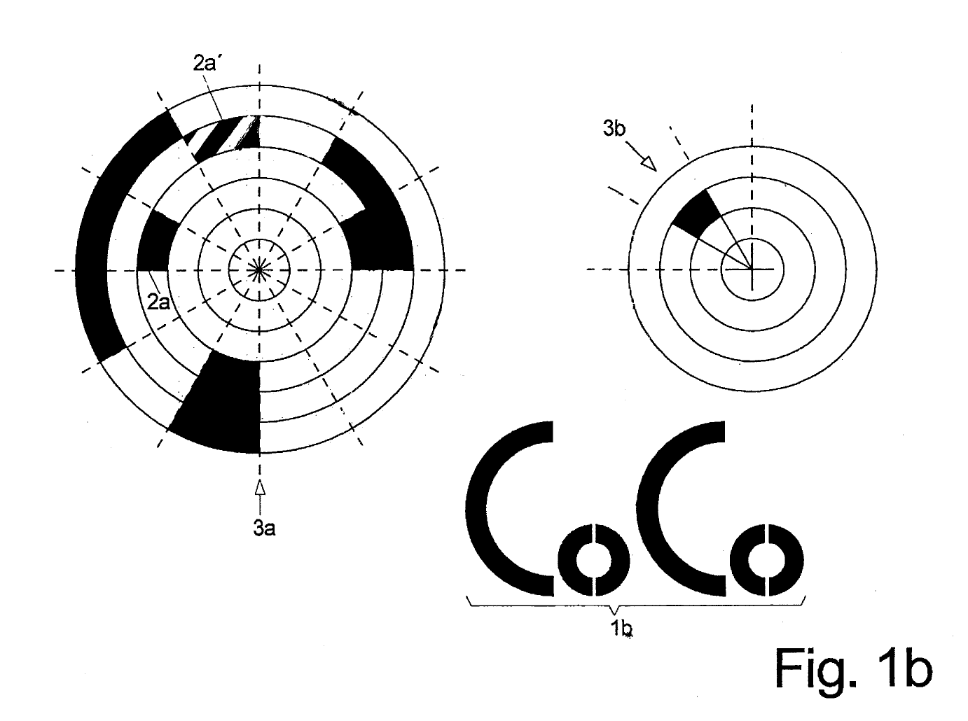

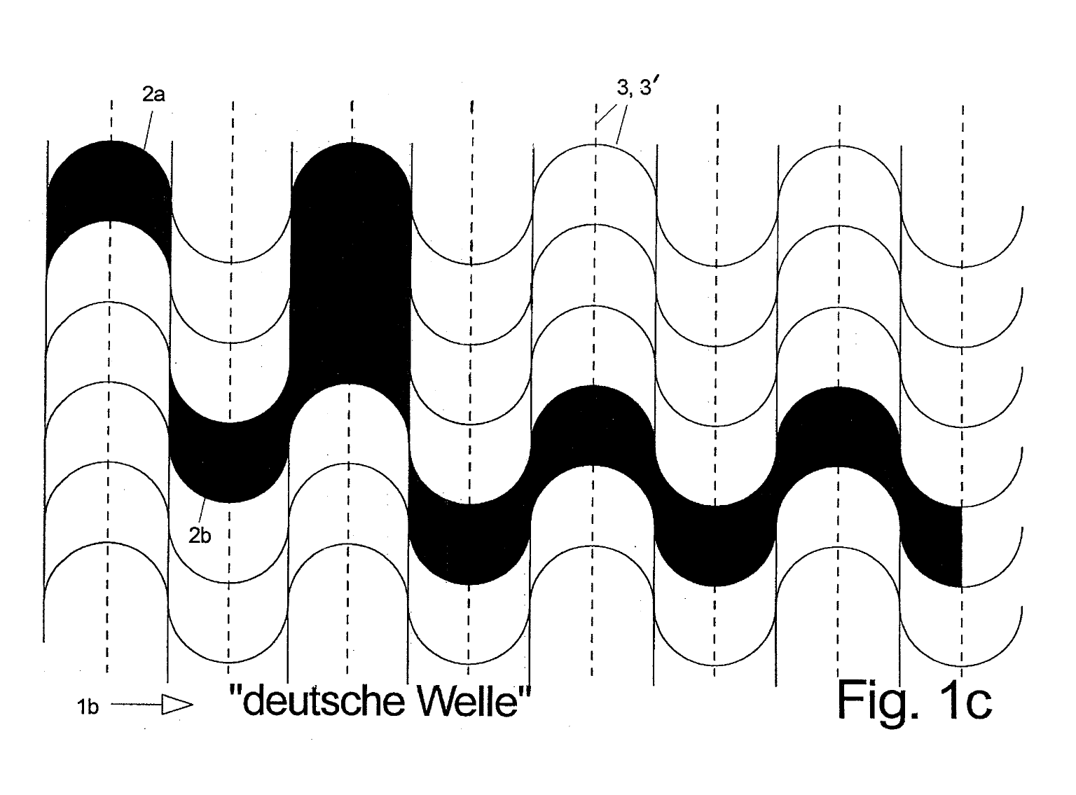

FIGS. 1 a to c in each case show in the right-hand or in the lower area the pre-defined basic logo 1b which should be supplemented by a coding part 1a.

In the example of FIG. 1a it is evident that the basic logo 1b illustrated there is aligned on horizontal and vertical axes at right-angles to one another and already contains squares as graphic components, of which even the entire basic logo can consist in this case.

Thus one of the possibilities on offer consisted in defining the matrix 3′, already pre-defined by the basic logo, as the coding matrix and the square, resulting from the dimension units, in each case equally large, in horizontal and vertical direction as geometric basic shape 2a, which are arranged in the coding part 1a to be produced as the coding symbol inside the matrix 3′.

This can be an actual square in accordance with FIG. 1a or a modified basic shape 2a′ arranged more softly with rounded corners and also both can be used in mixed format. As illustrated by the example of the non-rounded square 2a, the fact that all multiple arrangements of squares in the matrix such as rows, corner arrangements etc. can be formed from these basic components, is likewise beside the basic logo illustrated by way of example in the coding part 1a.

In the example of FIG. 1b it is evident that the pre-defined basic logo comprises semi-circles and complete circles as basic components, which is similar to polar coordinate system 3 or a plurality of polar coordinate systems 3a, 3b, which individually or together subsequently control the check area.

Then a segmental arc 2a of the polar coordinate system, in the present case a segmental arc of 30°, is offered as an individual geometric basic shape.

Instead of the fully filled out basic shape 2a a geometrically identical basic shape 2a′, which is only modified by hatching, could be used.

Also here multiple arrangements of these basic shapes 2a can result in larger circular arcs next to and behind one another, radially larger segments or other multiple arrangements, wherein—which should be the general rule—for better decodability basic shapes directly adjoining one another should contact each other not only intermittently, but along the entire common boundary line. In this case only basic shapes diagonally adjoining each other are excluded.

FIG. 1c shows an example, in which a wave matrix is used as matrix 3 and the geometric basic shapes 2a, b are half-waves or semi-circles curved upwards or downwards and thus in the present case content-wise linkage with the pre-defined concept of the basic logo 1b is created.

For example then the coding colors and background colors, still to be defined, can be also selected according to this concept, for example black and gold, while red is selected as the complementary color.

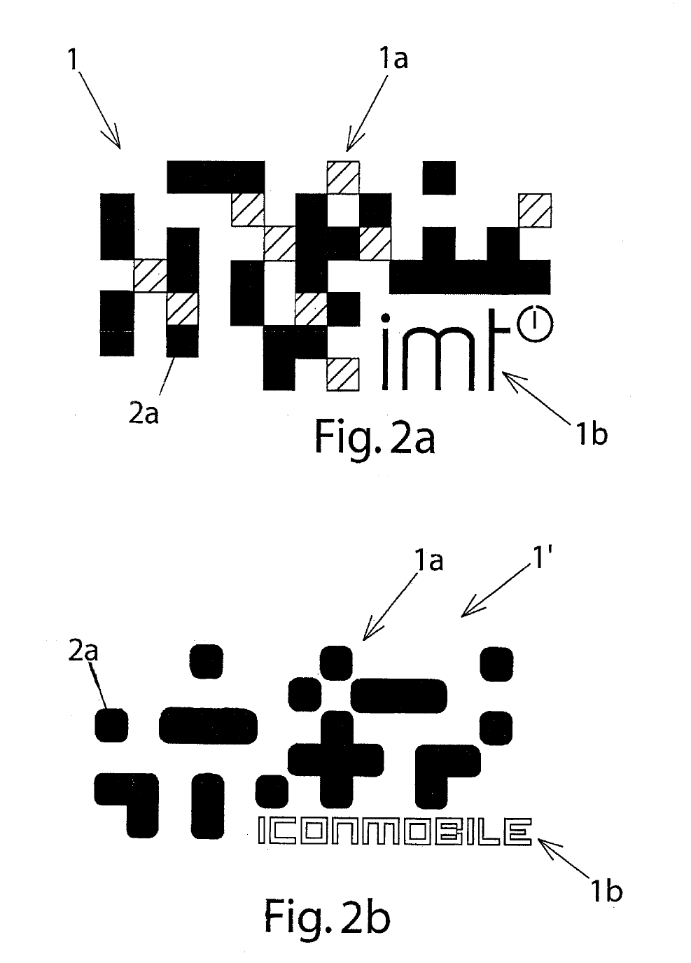

FIGS. 2a and b show two examples of a completed coded logo 1 or 1′ where the basic logo 1b, which has been pre-defined, in each case is located in the right lower region and the remainder of the region is the coding part 1a, which in FIG. 2a is composed of squares with pronounced corners and in FIG. 2b of squares with rounded corners.

The following figures show code symbols present in these logos 1 or 1′ and regions of the coding part 1a.

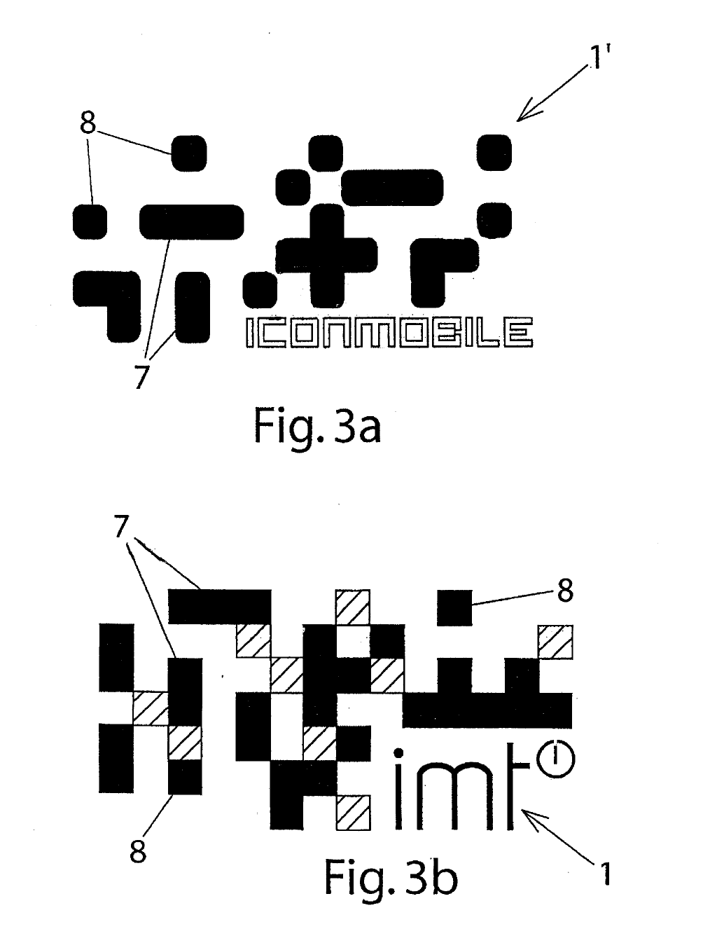

FIGS. 3a and b for the two logos 1 or 1′ show the two position code symbols 7 arranged in a defined pattern relative to each other and in a defined relative situation inside the coding part 1a, which define the position of the arrangement of the matrices on which the individual squares are based, and the two dimension-code symbols 8 in each case, which define the dimension of this matrix in horizontal and vertical direction.

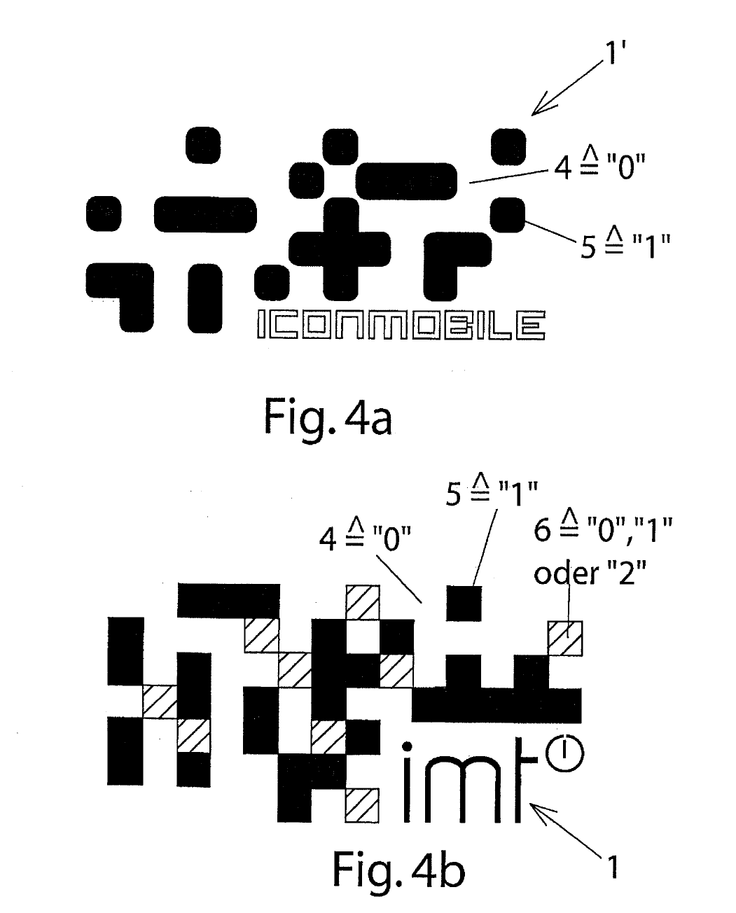

FIG. 4 a shows by way of the same logo 1, 1′ on the basis of individual squares, which color is allocated to which data content for filling out the squares as geometric basic shapes, in this case the coding color 5 corresponding to the data content “1” and the background color 4 corresponding to the data content “0”.

Only in the example of FIG. 4b is the so-called complementary color 6 used as the third color with some coding symbols, to which optionally an additional data content, for example “2” can be allocated or optionally the same data content as the coding color or background color, that is to say “0” or “1”, so that in the latter case the additional complementary color would only serve better optical detectability of the coding part.

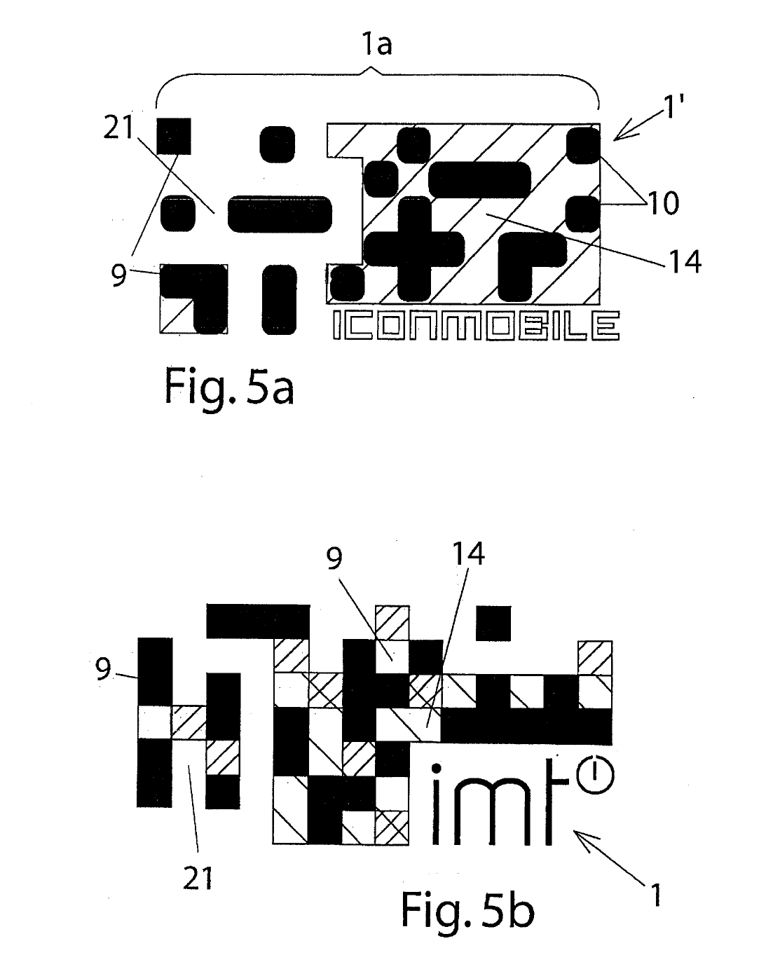

FIGS. 5a and b show, again by way of the example of the two logos 1 or 1′, the two check code symbols 9 in each case likewise arranged in a defined absolute position inside the matrix or in a defined relative position relative to each outer as well as the usable area 14 in each case embedded inside the coding part 1a, inside which the information to be exchanged is encoded. The borders of the usable region can be defined by the fixed code symbols, in particular their position, more particularly the position of the position code symbols 7, or stored separately in the coding algorithm.

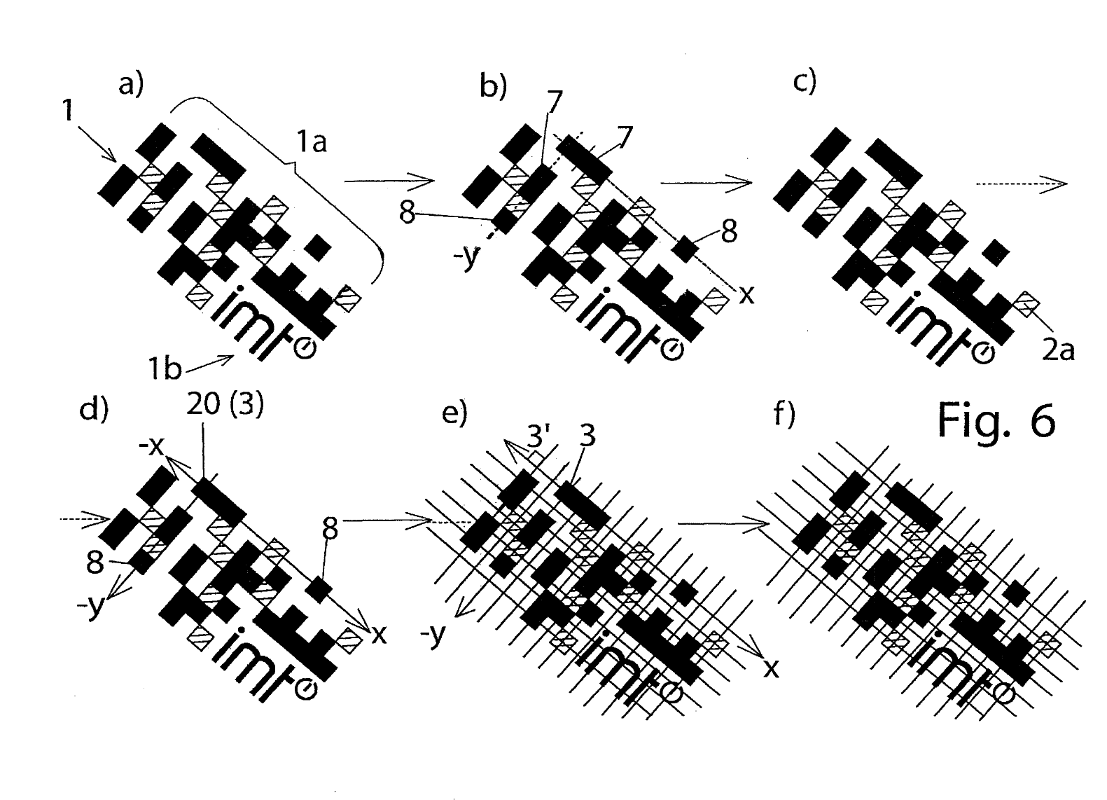

FIG. 6 shows the decoding procedure in steps a to f by way of the example the coded logo 1 already illustrated beforehand in the previous figures:

If the exchanged coded logo 1 is used, that is to say decoded by a user, and the information contained therein is to be used by him, usually the only manual action of the user consists in photographing the coded logo 1 detected with an optical sensor such as a digital CCD sensor for instance of a cellular phone.

In this case according to step a, the logo 1 will be arranged in any randomly rotated position to the face of the CCD sensor. The plane, in which the coded logo 1 is located, will not necessarily lie exactly parallel with the plane of the CCD sensor and therefore the coded part 1a of the matrix on which the logo 1 is based is differently distorted for example in the horizontal direction, that is to say shortened or extended, illustrated in the vertical direction of the matrix.

After photographing, the evaluation unit, which is downstream of the CCD sensor, automatically searches for the two position code symbols 7, which at least with respect to the arrangement and situation relative to one another the evaluation unit are known from the coding algorithm previously embedded there.

As soon as these are recognized, their exact position is fixed, for example by an ellipse embedded in each case in the coding algorithm, from which the ellipse parameters, such as ellipse axes, ellipse radii and intersections of the ellipse axes, are also known, being brought by the evaluation unit into optimum convergence with the code symbols 7 detected.

Thus the centre of each of the two position code symbols 7 can be defined accurately and the intersection of the two long semi-axes of the two ellipses embedded in the check symbols defines for example, in accordance with the coding algorithm, the zero point of the coordinate system 3, whose horizontal and vertical direction is also defined by the long semi-axes of the two position code symbols 7 (step d).

To define the dimension of the coding matrix 3′ embedded in this coordinate system 3 the evaluation unit in a position defined relative to the now already fixed zero point of the coordinate system searches for the two dimension code symbols 8 likewise contained in the coding part, which in this case are located at a certain distance on the positive abscissa and negative ordinate of the coordinate system 3.

The distance of these dimension code symbols 8 to the zero point indicates the dimension of the matrix in the horizontal and vertical direction, thus for example the code symbol 8 arranged on the abscissa lies on the seventh horizontal position of the zero point and the dimension code symbol 8 arranged on the ordinate lies on the fifth (negative) vertical position, so that the ⅛ or ⅕ of the respective distances from the zero point prescribes the dimension in the horizontal and vertical direction, which in this case coincides, since it concerns a square right-angled matrix.

Thus the evaluation unit, due to now accurate knowledge of the matrix 3′, inside which the individual basic shapes 2a are embedded as coding symbols, can decode these coding symbols corresponding to the parameter of the coding algorithm, thus for example can read out line by line, in each case in the horizontal direction successively the data content of the individual basic shapes, wherein the data content to be exchanged, which is only arranged in the usable area, must be differentiated from the code symbols, which are embedded in a code region 21.

For example here it could be established by the coding algorithm that the usable area is that part of the coding part (step e), which is located in the second square of the coordinate system, thus between the positive abscissa and the negative ordinate, while these two axes themselves as well as the remainder of the coding part 1a are considered as code region 21.

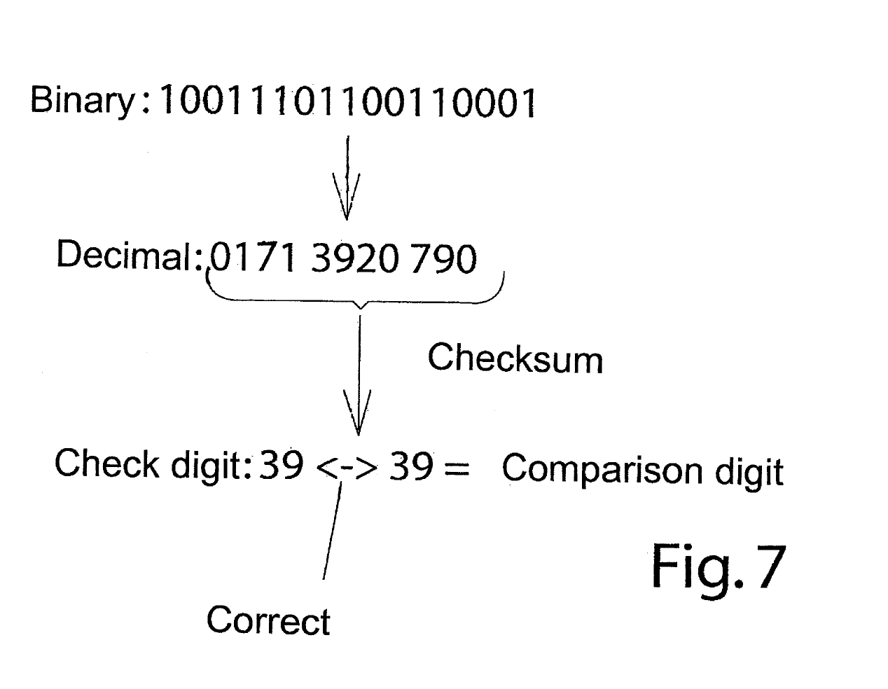

From this evaluation of the usable area 14 there results for example the binary sequence of numbers illustrated in FIG. 7, which converted by the evaluation unit into a decimal numerical system results in a sequence of the numbers to 9, which for example could represent a valid telephone number.

Check code symbols 9 are also present in the code region 21 of the coding part 1a (see FIGS. 5a and b), which were likewise also considered when the data content of the coding part 1a was read out and as data content contained a check digit, in this case “39”.

From the data content detected in the usable area, whether in binary or decimal format, a comparison digit is determined in a method likewise embedded in the coding algorithm, in this case as the checksum of the decimal numerical sequence computed. This comparison digit is checked for agreement with the check digit from check code symbol 9 and if there is agreement this means that the decoding has been carried out correctly.

The binary or also decimal numerical sequence determined in this way now frequently with the aid of the evaluation unit automatically triggers off a connection to a service provider, in order to receive from there, for example, further information or services or even goods.

Usually the information will be part of the advertising measures of the owner of the basic logo.

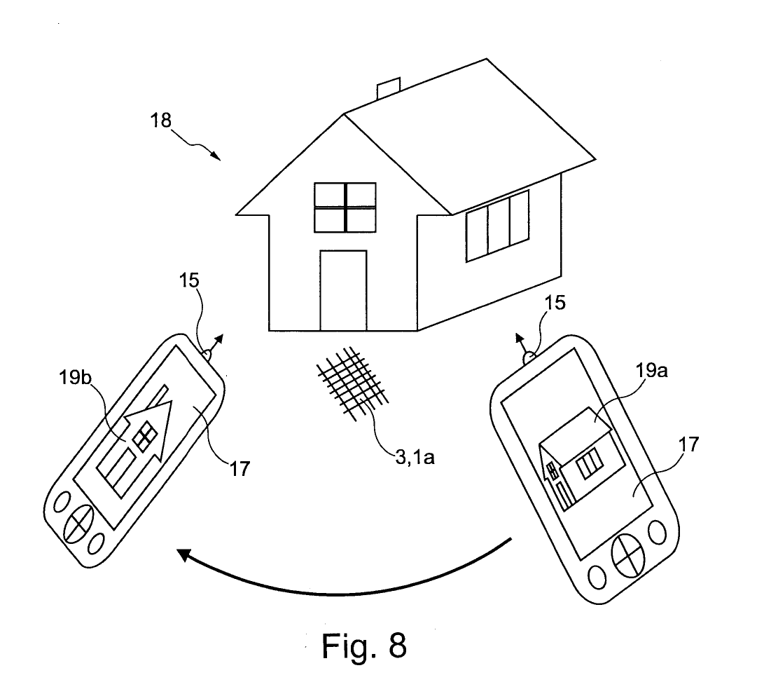

A possible particular application is shown in FIG. 8:

If for example the owner of the basic logo is an estate agent, his aim with the aid of the coded logo 1 could be to convey to the viewer of the coded logo more exact information about a property on sale through him.

The data content of the coded logo for example can show an internet address, which is automatically called by the evaluation unit and the connected cellular phone or computer of the user or if desired by the user.

The complete geometric data of the property concerned, and thus this property overall as a three-dimensional, virtual building, either only from the outside or also on the inside with accessible rooms, are stored on the server.

If now the coding part also contains a coding symbol as embedded data, whether as separate location code symbols 10 (see FIG. 5a), inside or outside the usable area or as a component of the normal useful information, which allows the evaluation unit of the CCD sensor to also determine the current location in addition to the one described beforehand, thus the line of sight and distance of the CCD sensor to the logo, then this location information can be used in addition.

If for example the evaluation unit makes contact with the estate agent's server, on which the data of the three-dimensional virtual building is stored, and additionally relays this location information, the latter can convey back to the evaluation unit a two-dimensional perspective view of the building, which corresponds to the distance and the line of sight of a viewer of the building, which the user's CCD sensor momentarily holds in the direction of the coded logo.

Assuming sufficient computer and transmission capacity, the user can therefore change the position of his CCD sensor relative to the coded logo, for example go completely in a circle around the logo, and will receive at the same time as this, from the estate agent's server, the ever changing perspective views of the building on his two-dimensional display, so that he can additionally get a complete visual impression of a three-dimensional object such as a building possibly also from the inside.

1. A method for exchanging digital information with the aid of an at least partly pre-defined basic logo, the method comprising:
providing a coding part associated with the basic logo, said providing including encoding the information using a coding algorithm based on arrangement and/or modification of a set of one or more selected geometric basic shapes selected from a set of geometric basic shapes,
providing said coding part and said basic logo in a viewable form;
optically scanning at least of the coding part;
recognizing the coding part; and
decoding the coding part, including detecting said arrangement and/or modification of one or more of said selected geometric basic shapes.

2.-31. (canceled)

32. A device for decoding information encoded according to a coding algorithm in connection with a non-coded basic logos comprising:
a digital optical sensor; and
an evaluation unit coupled to the digital optical sensor to implement a decoding algorithm that includes recognizing a coding part associated with the basic logo in an image obtained from the digital optical sensor, the coding part including information encoded based on an arrangement and/or modification of one or more selected geometric basic shapes and detecting said information based on the arrangement and/or modification of the geometric basic shapes.

33. A two-dimensional coding part, associated with a basic logo, comprising:
geometric basic shapes arranged as a matrix, wherein at least some of the geometric basic shapes are filled out either with a background color or with a coding color, alternately circulating on all sides along a border of said matrix wherein said background color and said coding color are to be used to encode information by filling in at least some of said geometric basic shapes within the matrix with the background color and/or the coding color.

34. A method of encoding information with the aid of an at least partly pre-defined basic logo, the method comprising:
providing a coding part associated with the basic logo, said providing including encoding the information using a coding algorithm based on arrangement and/or modification of a set of one or more selected geometric basic shapes selected from a set of geometric basic shapes; and
providing said coding part and said basic logo in a viewable form.

35. The method as claimed in claim 34, wherein said set of geometric basic shapes includes at least one shape selected from the set consisting of: square, triangle, lozenge, and circular arc segment.

36. The method as claimed in claim 34, wherein said set of selected geometric basic shapes contains geometric basic shapes selected based on geometric compatibility with at least one basic graphic component determined from the basic logo.

37. The method as claimed in claim 34, wherein an arrangement of the set of selected geometric basic shapes is defined based on one or more Cartesian and/or polar coordinate systems.

38. The method as claimed in claim 34, wherein said encoding comprises:
defining a coding matrix prior to said providing a coding part.

39. The method as claimed in claim 38, said coding matrix including at least two regions selected from the set consisting of: usable region, check region, and code region.

40. The method as claimed in claim 38, wherein an arrangement in the coding matrix is selected so that adjoining basic geometric shapes contact one another linearly along their boundaries.

41. The method as claimed in claim 34, wherein said modification comprises at least one modification selected from the set consisting of: modifying an outside contour of a geometric basic shape; and modifying a superficial content of a geometric basic shape.

42. The method as claimed in claim 34, wherein said modification comprises at least one modification selected from the set consisting of:
completely filling in a geometric basic shape;
providing a geometric basic shape with a background color and/or a coding color; and
providing a complementary color.

43. The method as claimed in claim 42, wherein information encoded using said complementary color is equated with either information encoded using a background color or information encoded using a coding color.

44. The method as claimed in claim 34, wherein said coding algorithm generates code symbols, and wherein the code symbols comprise at least one check code symbol.

45. The method as claimed in claim 44, wherein data corresponding to the at least one check code symbol includes at least one check digit to be checked for agreement with a comparison digit computed from useful data content of said information using a fixed algorithm.

46. The method as claimed in claim 34, wherein said coding algorithm generates code symbols, and the code symbols lie outside a usable region of the coding part in a separate code region.

47. The method as claimed in claim 34, wherein said providing a coding part includes establishing a border of the coding part, and wherein said establishing a border includes determining a usable region inside the coding part.

48. The method as claimed in claim 34, wherein the coding part comprises at least one location code symbol and at least one coding matrix-determining code symbol.

49. A method of decoding information encoded with the aid of an at least partly pre-defined basic logo, the method comprising:
recognizing a coding part associated with the basic logo, wherein the coding part includes information encoded based on an arrangement and/or modification of one or more selected geometric basic shapes; and
decoding the information encoded in the coding part based, including detecting said arrangement and/or modification of one or more of said selected geometric basic shapes.

50. The method as claimed in claim 49, wherein said selected geometric basic shapes are selected from a set of geometric basic shapes that includes at least one shape selected from the set consisting of: square, triangle, lozenge, and circular arc segment.

51. The method as claimed in claim 49, wherein said selected geometric basic shapes contains geometric basic shapes selected based on geometric compatibility with at least one basic graphic component determined from the basic logo.

52. The method as claimed in claim 49, wherein an arrangement of the selected geometric basic shapes is defined based on one or more Cartesian and/or polar coordinate systems.

53. The method as claimed in claim 49, further comprising:
triggering a routine dependent on data obtained based on said decoding.

54. The method as claimed in claim 53, wherein the routine comprises relaying said data to a service provider and receiving a response from the service provider.

55. The method as claimed in claim 54, wherein the routine further comprises triggering an additional routine dependent on said response from the service provider.

56. The method as claimed in claim 55, wherein the response from the service provider includes an internet address and the additional routine comprises the call-up of this address.

57. The method as claimed in claim 54, wherein the data received from the service provider comprises a direct transmission of a web page.

58. The method as claimed in claim 49, wherein said recognizing of the coding part comprises:
searching for one or more code symbols;
determining a position of one or more of the code symbols; and
detecting a code matrix based on the position and/or orientation of the one or more code symbols.

59. The method as claimed in claim 58, wherein said detecting a code matrix comprises:
determining the position and orientation of the one or more code symbols by determining ellipse parameters from pre-defined ellipses associated with the code symbols.

60. The method as claimed in claim 58, wherein the code symbols comprise at least two code symbols of defined shape and/or dimension, arranged in a pattern defined relative to one another.

61. The method as claimed in claim 58, wherein the code symbols include two position code symbols to define the position of the coding matrix, and wherein the code symbols further comprise at least one dimension code symbol to reflect the coding matrix dimension based on a position of the at least one dimension code symbol.

62. The method as claimed in claim 61, wherein there are at least two dimension code symbols, and wherein the coding matrix dimension is reflected in their distance from each other or from the position code symbols.

63. The method as claimed in claim 61, wherein said recognizing of the coding part comprises:
establishing borders of the coding part after the position and dimension of the coding matrix have been detected.

64. The method as claimed in claim 49, wherein said detecting comprises:
translating a color associated with each of the geometric basic shapes to a data symbol associated with that color.

65. The method as claimed in claim 49, wherein the encoded information includes at least one check digit, and wherein the method further comprises:
computing a comparison digit based on useful information decoded in said decoding; and
comparing said comparison digit with said check digit.

66. The method as claimed in claim 49, wherein the coding part comprises at least one location code symbol and at least one coding matrix-determining code symbol, wherein said recognizing is performed based on a scanned image obtained using a scanning apparatus, and wherein the method further comprises:
recognizing the at least one location code symbol; and
using the at least one location code symbol to determine a geometric position of the scanned image with respect to the scanning apparatus.

67. The method as claimed in claim 66, further comprising:
creating and displaying a virtual three-dimensional object in two-dimensional perspective view, dependent on the geometric position of the scanning apparatus with respect to the coding part.

68. A computer-readable medium containing program instructions that, when executed by a processor, cause the processor to implement the method as claimed in claim 49.

69. A computer-readable medium containing program instructions that, when executed by a processor, cause the processor to implement the method as claimed in claim 34.

70. The device as claimed in claim 32, further comprising:
means for accessing a remote data processor.

71. The device as claimed in claim 32, wherein said evaluation unit comprises a processor programmed to implement said decoding algorithm.
